(19) United States
(12) Patent Application Publication
(10) Pub. No.: US 2001/0018488 A1
(43) Pub. Date: Aug. 30, 2001

(54) Silicone molding compositions having extended useful life

(75) Inventor: John J. Fitzgerald, Clifton Park, NY (US)

Correspondence Address: Kenneth S. Wheelock, GE Plastics, One Plastics Avenue, Pittsfield, MA, 01201, US

(73) Assignee: General Electric Co.

(21) Appl. No.: 09/813,696

(22) Filed: Mar. 21, 2001

Related U.S. Application Data
(63) Continuation of application No. 08/525,253, filed on Sep. 8, 1995, now abandoned.

(51) Int. Cl. C08J 3/00

(52) U.S. Cl. 524/862

(57) ABSTRACT

Silicone mold making compositions containing an olefin polymerization inhibitor have a longer useful life for making casts from curable resins comprising a polymerizable olefin.

### FIELD OF THE INVENTION

The present invention relates to new room temperature vulcanizable or condensation cure silicone compositions having an extended useful life, wherein such compositions are molded into molds and used for the casting or molding of various useful articles of manufacture whereby such extended useful life is achieved by incorporating an olefin or acetylene polymerization inhibitor into the silicone composition.

### BACKGROUND OF THE INVENTION

Condensation cure elastomers as well as room temperature vulcanizable silicone compositions are used in a variety of mold making applications. Such molds are used to make a variety of three dimensional objects using curable or polymerizable resinous liquids. One particularly advantageous feature of such compositions for use in molds is that complicated and undercut objects may be directly molded by pouring the silicone around the object. Because of the elastomeric nature of the cured silicone, when the molded article has sufficiently hardened the mold may be pulled away from the object and undercut mold penetrations still release because of the elastomeric nature of the mold material. Complicated objects are thus easily mass produced. Typically such objects are figurines, art deco objects and the like.

Silicone elastomeric or room temperature vulcanizable molding compositions generally are composed a di-silanol terminated polydiorganosiloxane, a reinforcing filler, a crosslinking MT, MQ, or MTQ resin, and a condensation cure catalyst. It is particularly desirable that the mixture from which the mold (negative) is to be made have a low viscosity whereby the liquid will easily flow into the detail regions of the master (positive) thus creating the mold. Upon curing, the mold should have a high tear strength, good tensile strength, and good elongation to break. Additional materials added to the basic formulation should either improve these properties or at least a minimum adverse impact.

The material to be molded is initially a liquid or resinous precursor to a glassy or solid molded final state. The usual method is to employ a polymerizable liquid such as polyester-styrene resins. These materials undergo either a partial or complete polymerization within the silicone mold thereby solidifying. This process, particularly for polymerizable resins that are olefinic in nature is exothermic. Sometimes this process is highly exothermic. After repeated use, the molds begin to fail.

There are a variety of reasons that molds fail. Parts of the elastomer or room temperature vulcanizable silicone adhere to the material being molded, i.e. the casting resin. If adhesion occurs between the mold and the molded material, when the molded material is removed from the mold, parts of the mold are transferred to the resin. This process is called chunk out.

Another type of mold failure involves the formation of a surface crust on the contact surfaces of the mold. As a consequence of this surface crust the mold loses its flexibility and begins to tear. This also results in a loss of mold integrity.

Frequently associated with this surface crust is a discoloration of the silicone material forming the mold. This is termed burn out.

Silicone elastomeric rubber molds for the casting of resinous curable or polymerizable species are variously described in U.S. Pat. Nos. 5,013,772; 4,070,224; 3,856,908; and 3,801,430.

### SUMMARY OF THE INVENTION

The present invention relates to a curable silicone composition suitable for making molds enabling the mass production of molded articles wherein the curable silicone composition contains an additive that extends the useful life of the mold relative to a similar composition that does not contain the mold life-extending additive.

In a particular embodiment of the invention the present invention relates to curable silicone compositions that comprise olefin polymerization inhibitors. More particularly the present invention relates to silicone compositions that are condensation cure silicone compositions which comprise olefin or acetylene polymerization inhibitors.

Thus the present invention provides for a silicone composition for making casting molds comprising an olefin or acetylene polymerization inhibitor.

The present invention further provides for a curable silicone composition for making casting molds comprising:

(a) a di-silanol stopped linear polydimethylsiloxane having a viscosity ranging from about 10,000 to about 80,000 centipoise at 25° C.;

(b) a finely divided filler or mixtures thereof;

(c) a methyl stopped polydimethylsiloxane having a viscosity ranging from about 10 to about 350 centipoise at 25° C.;

(d) a methyl stopped polydimethylsiloxane having a viscosity ranging from about 400 to about 600 centipoise at 25° C.; and

(e) an olefin polymerization inhibitor wherein said composition totals 100 parts by weight

The present invention further provides for a curable silicone composition for making casting molds comprising:

(a) a silanol stopped hydrogen stopped polydimethylsiloxane having a viscosity ranging from about 10,000 to about 80,000 centipoise at 25° C.;

(b) a fumed silica having a surface area varying from 50 to 450 m²/g;

(c) a precipitated silica wherein said precipitated silica has been treated with hexamethyldisilazane and wherein said hexamethyldisilazane treated precipitated silica has a surface area ranging from about 50 to 175 m²/g;

(d) a methyl stopped polydimethylsiloxane having a viscosity ranging from about 10 to 350 centipoise at 25° C.;

(e) an olefin polymerization inhibitor; wherein said composition totals 100 parts by weight

The present invention further provides for a condensation cure silicone composition for making casting molds comprising an olefin or acetylene polymerization inhibitor.

The present invention further provides for a silicone composition for making casting molds consisting essentially of:

(a) a curable silicone composition, and

(b) an olefin or acetylene polymerization inhibitor wherein said polymerization inhibitor is selected from the group consisting of:

2,6-di-tertiary-butyl-para-cresol,

2-tertiary-butyl-4-methoxyphenol,

3-tertiary-butyl-4-methoxyphenol,

alkyl substituted phenol where the alkyl group has from 1 to 30 carbon atoms,

di-alkyl substituted phenol where each alkyl group independently has from one to 30 carbon atoms,

tri-alkyl substituted phenol where each alkyl group independently has from one to 30 carbon atoms,

styrylphenol,

di-styrylphenol,

tri-styrylphenol,

2,2′-methylenebis(4-methyl-6-tertiary-butylphenol),

2,2′-methylenebis(4-ethyl-6-tertiary-butylphenol),

4,4′-methylenebis(2,6-di-tertiary-butylphenol),

2,2′-ethylidenebis(4,6-di-tertiary-butylphenol),

2,2′-methylenebis(4-methyl-6-(1-methylcyclohexyl)-phenol),

4,4′-butylidenebis(6-tertiary-butyl-3-methylphenol),

4,4′-thiobis(6-tertiary-butyl-3-methylphenol),

4,4′-methylenebis(2,6-dimethylphenol),

1,1′-thiobis(2-naphthol),

2,2′-thiobis(4-methyl-6-tertiary-butylphenol),

2,2′-isobutylidenebis(4,6-dimethylphenol),

tetrakis(methylene 3-(3,5-di-tertary-butyl-4-hydroxyphenyl)propionate)methane,

1,3,5-trimethyl-2,4,6-tris(3,5-di-tertiary-butyl-4-hydroxybenzyl)-benzene,

1,3,5,-tris(3,5-di-tertiary-butyl-4-hydroxybenzyl)-s-triazine-2,4,6(1H,3H,5H)trione,

2,4-bis(n-octylthio)-6-(4-hydroxy-3,5-di-tertiary-butylamino) 1,3,5-triazine,

4-(hydroxymethyl)-2,6,-di-tertiary-butylphenol,

2,2-diphenyl-1-picrylhydrazyl,

dilauryl thiodipropionate,

distearyl thiodipropionate,

O,O-di-normal-octadecyl(3,5-di-tertiary-butyl-4-hydroxybenzyl)phosphonate,

1,6-hexamethylene bis(3,5-di-tertiary-butyl-4-hydroxyphenyl)propionate,

thiodiethylene bis(3,5-di-tertiary-butyl-4-hydroxyphenyl)propionate,

octadecyl 3-(3,5-di-tertiary-butyl-4-hydroxyphenyl)propionate,

N,N′-hexamethylene bis(3-(3,5-di-tertiary-butyl-4-hydroxyphenyl)propionamide,

1,3,5-tris(2-hydroxyethyl)-s-triazine-2,4,6-(1H,3H,5H)trione,

N-(4-hydroxyphenyl)butyramide,

N-(4-hydroxyphenyl)pelargonamide,

N-(4-hydroxyphenyl)dodecanamide,

N-(4-hydroxyphenyl)stearamide,

2,6-di-tertiary-butyl-4-(dimethylaminoethyl)phenol,

1,3,5-tris(4-tertiary-butyl-3-hydroxy-2,6-dimethylbenzyl-s-triazine-2,4,6-(1H,3H,5H)trione,

Nickel bis(O-ethyl(3,5-di-tertiary-butyl-4-hydroxybenzyl)phosphonate),

2,2′-oxamidobisethyl 3-(3,5-di-tertiary-butyl-4-hydroxyphenyl)propionate,

tris(2-tertiary-butyl-4-(2-methyl-4-hydroxy-5-tertiary-butylphenylthio)-5-methyl)phenylphosphite,

tetrakis (2,4-di-tertiary-butylphenyl) 4,4′-diphenylylenediphosphonite,

normal-propyl 3,4,5-tri-hydroxybenzoate,

calcium bis(O-ethyl(3,5-di-tertiary-butyl-4-hydroxybenzyl)phosphonate,

Banfield's radical,

1,3,5-triphenyl verdazyl,

Koelsch's radical,

1-nitroso-2-naphthol,

2,2′,6,6′-tetramethyl-1-piperidinyloxy,

galvinoxyl,

2,5-di-tertiaryamylhydroquinone,

tertiary-butylhydroquinone,

and methylhydroquinone.

### DETAILED DESCRIPTION OF THE INVENTION

Casting molds prepared from curable silicone formulations are made from room temperature vulcanizable or condensation curable silicone compositions. The terms room temperature vulcanizable and condensation cure are terms of art within the field of silicone chemistry. Room temperature vulcanizable silicones are those that polymerize or cure upon exposure to atmospheric water vapor. While the art names these compositions room temperature vulcanizable they can be cured at elevated temperatures when a more rapid cure rate is desired. Condensation cure silicone compositions typically are catalyzed by an organometallic condensation catalyst which is usually an organometallic tin compound, either a beta-diketonate tin compound or an alkyl tin carboxylate. The two types of formulations are not necessarily mutually exclusive.

Casting molds made from room temperature vulcanizable silicone compositions or condensation cure silicone compositions fail for a variety of reasons. One of these failure mechanisms involves the adherence of the silicone composition of the mold to the resin being shaped by the mold. When adhesion occurs and the cured cast resin is removed from the mold, parts of the mold are transferred to the cured resin. This phenomenon or process is called chunk-out.

Another failure mechanism involves the appearance of a hard crust on the surface of the mold. This hard crust interferes with the flexibility of the mold. Since flexibility is necessary to cast shapes having undercuts, this crust interferes with the use of the mold for its intended purpose.

Chemical analysis of failed molds has provided a basis for explaining mold failure. Casting resins used with silicone molds typically are mixtures of polyesters and styrene. Both components diffuse into the silicone mold. Since the cure catalyst used for the polyester styrene casting resin is dissolved in a solvent, the resin cure catalyst can also diffuse into the silicone. The cure catalyst initiates a polymerization of the polymerizable species that have diffused into the silicone mold and creates an interpenetrating polymer network of polystyrene and polyorganosiloxane which is accompanied by a hardened surface of the mold. Such a surface hardening is demonstrated by a change in the glass transition temperature of polydimethylsiloxane molds that have been contaminated with polystyrene. In this case the glass transition temperature has been raised from −120° C. to up to 70° C. This change in glass transition temperature explains the change in flexibility of the silicone mold because the modulus of the silicone has been changed.

Also, because there is an increased concentration of polystyrene at the surface of the mold there is a significant change in surface energy. The change in surface energy due to the presence of polystyrene or polystyrene polyester copolymers in the silicone polymer matrix increases the likelihood that the resin will adhere to the mold leading to chunk out.

These side reactions, occurring within the polymer matrix of the silicone mold, can be inhibited by incorporating compounds that inhibit the polymerization of olefinic species such as styrene. U.S. Pat. Nos. 5,290,888; 5,258,138; 4,792,639; 4,709,101; and 4,654,451 all deal with various aspects of the inhibition of olefin polymerization. Some of the polymerization inhibiting compounds include hindered amines, phosphites, and phenols while others include stable free radicals. Among these inhibitor compounds are:

2,6-di-tertiary-butyl-para-cresol,

2-tertiary-butyl-4-methoxyphenol,

3-tertiary-butyl-4-methoxyphenol,

alkyl substituted phenol where the alkyl group has from 1 to 30 carbon atoms,

di-alkyl substituted phenol where each alkyl group independently has from one to 30 carbon atoms,

tri-alkyl substituted phenol where each alkyl group independently has from one to 30 carbon atoms,

styrylphenol,

di-styrylphenol,

tri-styrylphenol,

2,2′-methylenebis(4-methyl-6-tertiary-butylphenol),

2,2′-methylenebis(4-ethyl-6-tertiary-butylphenol),

4,4′-methylenebis(2,6-di-tertiary-butylphenol),

2,2′-ethylidenebis(4,6-di-tertiary-butylphenol),

2,2′-methylenebis(4-methyl-6-(1-methylcyclohexyl)-phenol),

4,4′-butylidenebis(6-tertiary-butyl-3-methylphenol),

4,4′-thiobis(6-tertiary-butyl-3-methylphenol),

4,4′-methylenebis(2,6-dimethylphenol),

1,1′-thiobis(2-naphthol),

2,2′-thiobis(4-methyl-6-tertiary-butylphenol),

2,2′-isobutylidenebis(4,6-dimethylphenol),

tetrakis(methylene 3-(3,5-di-tertary-butyl-4-hydroxyphenyl)propionate)methane,

1,3,5-trimethyl-2,4,6-tris(3,5-di-tertiary-butyl-4-hydroxybenzyl)-benzene,

1,3,5,-tris(3,5-di-tertiary-butyl-4-hydroxybenzyl)-s-triazine-2,4,6(1H,3H,5H)trione,

2,4-bis(n-octylthio)-6-(4-hydroxy-3,5-di-tertiary-butylamino) 1,3,5-triazine, 4-(hydroxymethyl)-2,6,-di-tertiary-butylphenol,

2,2-diphenyl-1-picrylhydrazyl,

dilauryl thiodipropionate,

distearyl thiodipropionate,

O,O-di-normal-octadecyl(3,5-di-tertiary-butyl-4-hydroxybenzyl)phosphonate,

1,6-hexamethylene bis(3,5-di-tertiary-butyl-4-hydroxyphenyl)propionate,

thiodiethylene bis(3,5-di-tertiary-butyl-4-hydroxyphenyl)propionate,

octadecyl 3-(3,5-di-tertiary-butyl-4-hydroxyphenyl)propionate,

N,N′-hexamethylene bis(3-(3,5-di-tertiary-butyl-4-hydroxyphenyl)propionamide,

1,3,5-tris(2-hydroxyethyl)-s-triazine-2,4,6-(1H,3H,5H)trione,

N-(4-hydroxyphenyl)butyramide,

N-(4-hydroxyphenyl)pelargonamide,

N-(4-hydroxyphenyl)dodecanamide,

N-(4-hydroxyphenyl)stearamide,

2,6-di-tertiary-butyl-4-(dimethylaminoethyl)phenol,

1,3,5-tris(4-tertiary-butyl-3-hydroxy-2,6-dimethylbenzyl-s-triazine-2,4,6-(1H,3H,5H)trione,

Nickel bis(O-ethyl(3,5-di-tertiary-butyl-4-hydroxybenzyl)phosphonate),

2,2′-oxamidobisethyl 3-(3,5-di-tertiary-butyl-4-hydroxyphenyl)propionate,

tris(2-tertiary-butyl-4-(2-methyl-4-hydroxy-5-tertiary-butylphenylthio)-5-methyl)phenylphosphite,

tetrakis (2,4-di-tertiary-butylphenyl) 4,4′-diphenylylenediphosphonite,

normal-propyl 3,4,5-tri-hydroxybenzoate,

calcium bis(O-ethyl(3,5-di-tertiary-butyl-4-hydroxybenzyl)phosphonate,

Banfield's radical,

1,3,5-triphenyl verdazyl,

Koelsch's radical,

1-nitroso-2-naphthol,

2,2′,6,6′-tetramethyl-1-piperidinyloxy,

galvinoxyl,

2,5-di-tertiaryamylhydroquinone,

tertiary-butylhydroquinone, and methylhydroquinone. Applicant notes that many of the compounds listed in the foregoing list are commercially available and sold under trademarked names by their respective manufacturers.

The preferred embodiments of Applicants invention are:

I. a silicone composition for making casting molds comprising an olefin or acetylene polymerization inhibitor;

II. a curable silicone composition for making casting molds comprising:

(a) 5 to 95 parts, preferably 10 to 90 parts and most preferably 20 to 50 parts by weight of a di-silanol stopped linear polydimethylsiloxane having a viscosity ranging from about 10,000 to about 80,000 centipoise at 25° C.;

(b) 1 to 70 parts, preferably 5 to 60 parts, and most preferably 10 to 40 parts by weight of a finely divided filler or mixtures thereof;

(c) 1 to 30 parts, preferably 3 to 25 parts, and most preferably 5 to 15 parts by weight of a methyl stopped polydimethylsiloxane having a viscosity ranging from about 10 to about 350 centipoise at 25° C.;

(d) 1 to 60 parts, preferably 3 to 45 parts, and most preferably 5 to 30 parts by weight of a methyl stopped polydimethylsiloxane having a viscosity ranging from about 400 to about 600 centipoise at 25° C.; and

(e) 0.00001 to 10 parts, preferably 0.0001 to 7 parts, and most preferably 0.001 to 2 parts by weight of an olefin polymerization inhibitor wherein said composition totals 100 parts by weight;

III. a curable silicone composition for making casting molds comprising:

(a) 5 to 95 parts, preferably 10 to 90 parts and most preferably 20 to 50 parts by weight of a silanol stopped hydrogen stopped polydimethylsiloxane having a viscosity ranging from about 10,000 to about 80,000 centipoise at 25° C.;

(b) 1 to 70 parts, preferably 5 to 60 parts, and most preferably 5 to 40 parts by weight of a fumed silica having a surface area varying from 50 to 450 m²/g;

(c) 1 to 30 parts, preferably 1 to 25 parts, and most preferably 1 to 15 parts by weight of a precipitated silica wherein said precipitated silica has been treated with hexamethyldisilazane and wherein said hexamethyldisilazane treated precipitated silica has a surface area ranging from about 50 to 175 m²/g;

(d) 1 to 70 parts, preferably 5 to 50 parts, and most preferably 10 to 30 parts by weight of a methyl stopped polydimethylsiloxane having a viscosity ranging from about 10 to 350 centipoise at 25° C.;

(e) 0.00001 to 10 parts, preferably 0.0001 to 7 parts, and most preferably 0.001 to 2 parts by weight of an olefin polymerization inhibitor; wherein said composition totals 100 parts by weight;

IV. a condensation cure silicone composition for making casting molds comprising an olefin or acetylene polymerization inhibitor;

V. a silicone composition for making casting molds consisting essentially of:

(a) a curable silicone composition, and

(b) an olefin or acetylene polymerization inhibitor wherein said polymerization inhibitor is selected from the group consisting of:

2,6-di-tertiary-butyl-para-cresol (butylated hydroxy toluene or BHT),

2-tertiary-butyl-4-methoxyphenol,

3-tertiary-butyl-4-methoxyphenol,

alkyl substituted phenol where the alkyl group has from 1 to 30 carbon atoms,

di-alkyl substituted phenol where each alkyl group independently has from one to 30 carbon atoms,

tri-alkyl substituted phenol where each alkyl group independently has from one to 30 carbon atoms,

styrylphenol,

di-styrylphenol,

tri-styrylphenol,

2,2′-methylenebis(4-methyl-6-tertiary-butylphenol),

2,2′-methylenebis(4-ethyl-6-tertiary-butylphenol),

4,4′-methylenebis(2,6-di-tertiary-butylphenol),

2,2′-ethylidenebis(4,6-di-tertiary-butylphenol),

2,2′-methylenebis(4-methyl-6-(1-methylcyclohexyl)-phenol),

4,4′-butylidenebis(6-tertiary-butyl-3-methylphenol),

4,4′-thiobis(6-tertiary-butyl-3-methylphenol),

4,4′-methylenebis(2,6-dimethylphenol),

1,1′-thiobis(2-naphthol),

2,2′-thiobis(4-methyl-6-tertiary-butylphenol),

2,2′-isobutylidenebis(4,6-dimethylphenol),

tetrakis(methylene 3-(3,5-di-tertary-butyl-4-hydroxyphenyl)propionate)methane,

1,3,5-trimethyl-2,4,6-tris(3,5-di-tertiary-butyl-4-hydroxybenzyl)-benzene,

1,3,5,-tris(3,5di-tertiary-butyl-4-hydroxybenzyl)-s-triazine-2,4,6(1H,3H,5H)trione,

2,4-bis(n-octylthio)-6-(4-hydroxy-3,5-di-tertiary-butylamino) 1,3,5-triazine,

4-(hydroxymethyl)-2,6,-di-tertiary-butylphenol,

2,2-diphenyl-1-picrylhydrazyl,

dilauryl thiodipropionate,

distearyl thiodipropionate,

O,O-di-normal-octadecyl(3,5-di-tertiary-butyl-4-hydroxybenzyl)phosphonate,

1,6-hexamethylene bis(3,5-di-tertiary-butyl-4-hydroxyphenyl)propionate,

thiodiethylene bis(3,5-di-tertiary-butyl-4-hydroxyphenyl)propionate,

octadecyl 3-(3,5-di-tertiary-butyl-4-hydroxyphenyl)propionate,

N,N′-hexamethylene bis(3-(3,5-di-tertiary-butyl-4-hydroxyphenyl)propionamide,

1,3,5-tris(2-hydroxyethyl)-s-triazine-2,4,6-(1H,3H,5H)trione,

N-(4-hydroxyphenyl)butyramide,

N-(4-hydroxyphenyl)pelargonamide,

N-(4-hydroxyphenyl)dodecanamide,

N-(4-hydroxyphenyl)stearamide,

2,6-di-tertiary-butyl-4-(dimethylaminoethyl)phenol,

1,3,5-tris(4-tertiary-butyl-3-hydroxy-2,6-dimethylbenzyl-s-triazine-2,4,6-(1H,3H,5H)trione,

Nickel bis(O-ethyl(3,5-di-tertiary-butyl-4-hydroxybenzyl)phosphonate),

2,2′-oxamidobisethyl 3-(3,5-di-tertiary-butyl-4-hydroxyphenyl)propionate,

tris(2-tertiary-butyl-4-(2-methyl-4-hydroxy-5-tertiary-butylphenylthio)-5-methyl)phenylphosphite,

tetrakis (2,4-di-tertiary-butylphenyl) 4,4′-diphenylylenediphosphonite,

normal-propyl 3,4,5-tri-hydroxybenzoate,

calcium bis(O-ethyl(3,5-di-tertiary-butyl-4-hydroxybenzyl)phosphonate,

Banfield's radical,

1,3,5-triphenyl verdazyl,

Koelsch's radical,

1-nitroso-2-naphthol,

2,2′,6,6′-tetramethyl-1-piperidinyloxy,

galvinoxyl,

2,5-di-tertiaryamylhydroquinone,

tertiary-butylhydroquinone,

and methylhydroquinone.

### Definitions

The following compounds have been referred to in previous sections of this specification and under the condition that the name referred to in the specification is not sufficiently specific are hereby defined by Applicant by their chemical structures as follows:

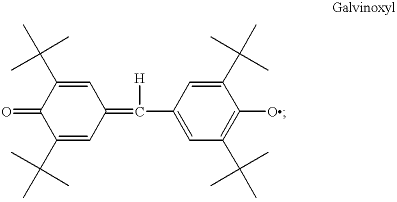

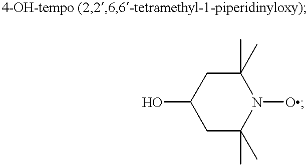

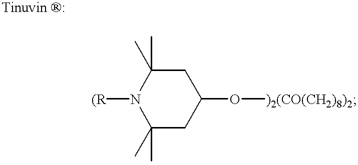

, where R is hydrogen for Tinuvin 770®, thus R may be selected from the group consisting of hydrogen, and monovalent hydrocarbon radicals of from one to about thirty carbon atoms;

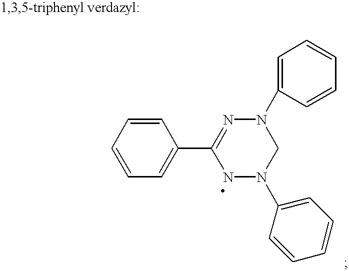

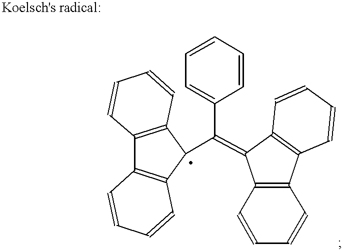

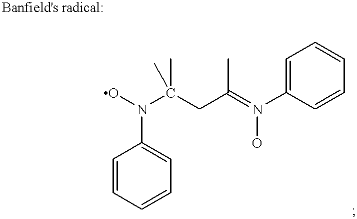

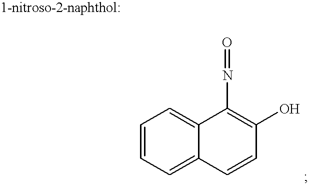

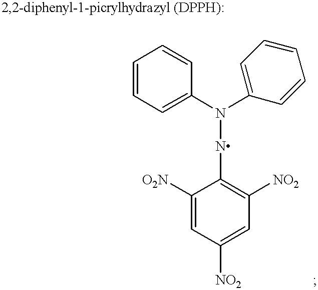

Where the phrase degree of polymerization is used in this specification the general sense of such phrase is to be intercepted as the average number of repeat units in the chemical formula of the polymer. Thus, a linear polydimethylsiloxane (PDMS), having an average degree of polymerization, x, and being a methyl stopped (M) polymer has the general formula MDₓM, with M being (CH₃)₃SiO_{1/2}, and D being (CH₃)₂SiO_{2/2}. Thus, in the previous general formula, the average degree of polymerization, x, being for example 100 indicates that the average value of the stoichiometric subscript, x, is 100. Applicant notes that there is a reasonable correlation between viscosity and molecular weight, particularly for linear silicone polymers.

Where the phrase condensation cure has been used in this specification or the claims appended hereto it is a term of art as defined and used in the following U.S. Pat. Nos. 5,420,196; 5,232,982; 5,212,017; 4,966,922; 4,563,498; 4,555,420; and 4,525,391.

It is the sense of Applicant's invention that compounds which inhibit the polymerization of olefins or acetylenes when incorporated into a curable silicone composition, particularly a silicone composition that is used to make casting molds wherein olefinic resins, acetylenic resins, or mixtures thereof are molded and polymerized therein, whereby the useful mold life of such a silicone composition when cured is extended beyond that ordinarily achievable with similar compositions absent the olefin polymerization inhibitor. Thus while Applicant has specifically enumerated several olefin and acetylenic polymerization inhibitor compounds, the scope of Applicant's invention subtends all of those compounds which inhibit the polymerization of olefins and acetylenes when they are incorporated into a curable silicone composition used for making casting molds.

All U.S. patents referenced herein are herewith and hereby specifically incorporated by reference.

### Experimental

Three different mold making compositions were evaluated with and without the presence of olefin polymerization inhibitors.

Composition A:

1) 33.42 parts by weight of di-silanol stopped linear polydimethylsiloxane having a viscosity ranging from 10,000 to 80,000 centipoise at 25° C.;

2) 12.55 parts by weight of a linear methyl stopped polydimethylsiloxane having a viscosity of 400 to 600 centipoise at 25° C.;

3) 28.63 parts by weight of finely divided quartz;

4) 1.67 parts by weight of a precipitated silica that has been treated with hexamethyldisilazane having a surface area ranging between about 130 and about 225 m²/g;

5) 1.47 parts by weight of hexamethydisilazane;

6) 8.39 parts by weight of a fumed or pyrogenic silica having a surface area of ranging between about 130 and about 225 m²/g;

7) 12.16 parts by weight of a methyl stopped polydimethylsiloxane having a viscosity of about 10 to 350 centipoise at 25° C.;

8) 0.30 parts by weight of a di-silanol stopped polydimethylsiloxane having a viscosity of about 10 to about 100 centipoise at 25° C.;

9) 1.41 parts by weight of water; with a total weight of about 100 parts by weight before the addition of other ingredients such as cure components, fillers, extending polymer and the like.

Composition B:

1) 44.22 parts by weight of a silanol stopped hydride stopped polydimethylsiloxane having a viscosity ranging from about 10,000 to about 80,000 centipoise at 25° C.;

2) 16.36 parts by weight of a fumed silica treated with hexamethyldisilazane having a surface area of 225 m²/g;

3) 1.95 parts by weight of a precipitated silica treated with hexamethyldisilazane having a surface area ranging between about of 130 and about 225 m²/g;

4) 17.03 parts by weight of a methyl stopped polydimethylsiloxane having a viscosity of 10 to 350 centipoise at 25° C.;

5) 1.15 parts by weight of a di-silanol stopped polydimethylsiloxane having a viscosity of 10 to 100 centipoise at 25° C.;

6) 18.95 parts by weight of tertiary-butoxy stopped, silanol stopped polydimethylsiloxane having a viscosity ranging from about 3,000 to about 5,000 centipoise at 25° C.; and

7) 0.34 parts by weight of titanium dioxide; with a total weight of about 100 parts by weight before the addition of other ingredients such as cure components, fillers, extending polymer and the like.

Composition C (V-1065): Is a commercially available curable silicone composition for making casting molds available from Visolox Systems Inc., Poestenkill, N.Y. 12140.

Catalyst systems for the curing of the silicone composition are defined for catalyst 1 and catalyst 2 as follows:

Composition of Catalyst 1:

45.14 parts by weight of vinyl stopped polydimethylsiloxane having an average degree of polymerization of 400;

37.68 parts by weight of tetra-propyl orthosilicate;

6.28 parts by weight of iso-propyl alcohol;,

0.13 parts by weight water; and

10.77 parts by weight of dibutyl tin dilaurate; adding to 100.00 parts by weight

Composition of Catalyst 2:

69.28 parts by weight of methyl stopped polydimethylsiloxane having an average degree of polymerization of 50;

20.61 parts by weight of tetra-propyl-orthosilicate;

3.44 parts by weight of normal propyl alcohol;

0.07 parts by weight water;

4.61 parts by weight of dibutyl tin oxide; and

2.00 parts by weight of a mixture of 40 weight percent Na₆Al₆Si₆O₂₄S₄ and 60 weight percent polydimethylsiloxane vinyl containing polymer having an viscosity of 3,600 centipoise at 25° C. degree and a vinyl content of 0.01 weight percent, adding to 100.01 parts by weight

Hi-Pro Green®:

A commercially available catalyst formulation for curable silicone mold compositions available from Visolox Systems Inc., Poestenkill, N.Y. 12140.

To compositions A, B, and C was added varying amounts of condensation cure catalysts and various olefin polymerization inhibitors. These compositions were then used to form casting molds around a three dimensional figure. The molds so formed were used to make casts with a polyester styrene resin and the useful life of the mold evaluated after 35 and 65 casts had been made with each mold.

The following table summarizes the molds made with the various mold making compositions both with and without the olefin polymerization inhibitor present in the mold making composition and evaluates the useful life of the molds made with the various compositions.

TABLE 1
Mold Making Compositions Containing Olefin Polymerization
Inhibitors

| Mold Composition | | | | |
|---|---|---|---|---|
| weights in grams | | | | |
| | I | II | III | IV |
| Composition | | | | |
| A | 0 | 0 | 400 | 400 |
| B | 400 | 0 | 0 | 0 |
| C | 0 | 400 | 0 | 0 |
| Catalyst | | | | |
| catalyst 1 | 40 | 0 | 0 | 0 |
| catalyst 2 | 0 | 0 | 40 | 40 |
| Hi-Pro Green ® | 0 | 40 | 0 | 0 |
| Inhibitor | | | | |
| BHT | 0 | 0 | 0 | 8 |
| Galvinoxyl | 0 | 0 | 0 | 0 |
| 4-OH-Tempo | 0 | 0 | 0 | 0 |
| Mold quality after | | | | |
| 35 pours | b/h/p | b/s | b/s | SI |
| 65 pours | b/d/p | b/h | b/h | nm |
| | V | VI | VII | VIII |
| Composition | | | | |
| A | 400 | 400 | 400 | 0 |
| B | 0 | 0 | 0 | 400 |
| C | 0 | 0 | 0 | 0 |
| Catalyst | | | | |
| catalyst 1 | 0 | 0 | 0 | 40 |
| catalyst 2 | 40 | 40 | 40 | 0 |
| Hi-Pro Green ® | 0 | 0 | 0 | 0 |
| Inhibitor | | | | |
| BHT | 2 | 1 | 0.4 | 2 |
| Galvinoxyl | 0 | 0 | 0 | 0 |
| 4-OH-Tempo | 0 | 0 | 0 | 0 |
| Mold quality after | | | | |
| 35 pours | E | E | E | E |
| 65 pours | B | B | B | B |
| | IX | X | | |
| Composition | | | | |
| A | 400 | 400 | | |
| B | 0 | 0 | | |
| C | 0 | 0 | | |
| Catalyst | | | | |
| catalyst 1 | 0 | 0 | | |
| catalyst 2 | 40 | 40 | | |
| Hi-Pro Green ® | 0 | 0 | | |
| Inhibitor | | | | |
| BHT | 0 | 0 | | |
| Galvinoxyl | 0.4 | 0 | | |
| 4-OH-Tempo | 0 | 0.4 | | |
| Mold quality after | | | | |
| 35 pours | E | E | | |
| 65 pours | B | B | | |

Notes to Table 1: b = burn out, h = hardening of mold, p = poor quality of mold, s = mold still soft, SI = inhibition at surface due to excessive amount of polymerization inhibitor, E = excellent, B = better than control and V-1065, nm = not measured.

TABLE 2
Mold Making Compositions Containing Olefin Polymerization
Inhibitors

| Mold Composition | | | | |
|---|---|---|---|---|
| weights in grams | XI | XII | XIII | XIV |
| Composition | | | | |
| A | 400 | 400 | 400 | 400 |
| B | 0 | 0 | 0 | 0 |
| C | 0 | 0 | 0 | 0 |
| Catalyst | | | | |
| catalyst 1 | 0 | 0 | 0 | 0 |
| catalyst 2 | 40 | 40 | 40 | 40 |
| Hi-Pro Green ® | 0 | 0 | 0 | 0 |
| Inhibitor | | | | |
| Tinuvin 770 ® | 0.4 | 0 | 0 | 0 |
| BHA | 0 | 0.4 | 0 | 0 |
| DPPH | 0 | 0 | 0.4 | 0 |
| BHT | 0 | 0 | 0 | 0.2 |
| Mold quality after | | | | |
| 35 pours | B | E | E | E |
| 65 pours | B | B | B | B |

Notes to Table 1: b = burn out, h = hardening of mold, p = poor quality of mold, s = mold still soft, SI = inhibition at surface due to excessive amount of polymerization inhibitor, E = excellent, B = better than control and V-1065, nm = not measured.

These results indicate that the addition of an amount of polymerization inhibitor in a range from about 0.00001 to about 10 weight percent improves the useful life of the mold by at least 25 percent, generally 50 percent and up to as much as about 100 to about 200 percent and improves the quality of the castings made with a mold containing such an inhibitor.

Having described the invention that which is claimed is

1. A silicone composition for making molds comprising an olefin or acetylene polymerization inhibitor.

2. The composition of claim 1 wherein said silicone composition is a condensation curable silicone composition.

3. A curable silicone composition for making casting molds comprising:
(a) a di-silanol stopped linear polydimethylsiloxane having a viscosity ranging from about 10,000 to about 80,000 centipoise at 25° C.;
(b) a finely divided filler or mixtures thereof;
(c) a methyl stopped polydimethylsiloxane having a viscosity ranging from about 10 to about 350 centipoise at 25° C.;
(d) a methyl stopped polydimethylsiloxane having a viscosity ranging from about 400 to about 600 centipoise at 25° C.; and
(e) an olefin polymerization inhibitor.

4. The composition of claim 3 wherein said silicone composition comprises a condensation cure catalyst.

5. A curable silicone composition for making casting molds comprising:
(a) a silanol stopped hydrogen stopped polydimethylsiloxane having a viscosity ranging from about 10,000 to about 80,000 centipoise at 25° C.;
(b) a fumed silica having a surface area varying from 50 to 450 m²/g;
(c) a precipitated silica wherein said precipitated silica has been treated with hexamethyldisilazane and wherein said hexamethyldisilazane treated precipitated silica has a surface area ranging from about 50 to 175 m²/g;
(d) a methyl stopped polydimethylsiloxane having a viscosity ranging from about 10 to 350 centipoise at 25° C.;
(e) an olefin polymerization inhibitor.

6. The composition of claim 5 wherein said silicone composition comprises a condensation cure catalyst.

7. A condensation cure silicone composition for making molds comprising an olefin polymerization inhibitor.

8. A silicone composition for making molds consisting essentially of:
(a) a curable silicone composition, and
(b) an olefin or acetylene polymerization inhibitor.

9. The composition of claim 8 wherein said curable silicone composition comprises a condensation cure catalyst.

10. The composition of claim 1 wherein said polymerization inhibitor is 2,6-di-tertiary-butyl-para-cresol.
